(19) United States
(12) Patent Application Publication
(10) Pub. No.: US 2014/0218782 A1
(43) Pub. Date: Aug. 7, 2014

(54) WAVELENGTH TUNABLE LIGHT SOURCE

(71) Applicant: Electronics and Telecommunications Research Institute, Daejeon (KR)

(72) Inventors: Oh Kee KWON, Daejeon (KR); Kwang Ryong OH, Daejeon (KR); Young-Tak HAN, Daejeon (KR)

(73) Assignee: Electronics and Telecommunications Research Institute, Daejeon (KR)

(21) Appl. No.: 14/105,937

(22) Filed: Dec. 13, 2013

(30) Foreign Application Priority Data
Feb. 6, 2013 (KR) 10-2013-0013436

(51) Int. Cl. G02F 1/25; G02F 1/01

(52) U.S. Cl. CPC G02F 1/25; G02F 1/0123
USPC 359/278

(57) ABSTRACT

Provided is a wavelength tunable light source including a super luminescent diode (SLD) generating lights in a predetermined wavelength band, a voltage generating unit generating first and second voltages, a first filter receiving the first voltage from the voltage generating unit, receiving the lights from the SLD, and transmitting, as second lights, lights corresponding to wavelengths separated by a free spectral range (FSR) from each other among the received lights, a second filter receiving the second voltage from the voltage generating unit, receiving the second lights from the first filter, and transmitting, as a third light, a light corresponding to one wavelength among the separated wavelengths among the received second light, and a reflective mirror disposed at an output end of the second filter and reflects the third light transmitted from the second filter.

### CROSS-REFERENCE TO RELATED APPLICATIONS

This U.S. non-provisional patent application claims priority under 35 U.S.C. §119 of Korean Patent Application No. 10-2013-0013436, filed on Feb. 6, 2013, the entire contents of which are hereby incorporated by reference.

### BACKGROUND OF THE INVENTION

The present invention disclosed herein relates to a wavelength tunable light source and more particularly to a wavelength tunable light source using an external resonator.

Wavelength tunable light sources enable wavelengths of output lights thereof to be tunable and are used in various application fields. For example, the wavelength tunable light sources are used for optical sensing, optical communication, medical equipments, and measurement devices.

The wavelength tunable light sources are divided into an external cavity type, a fiber ring cavity type, and an integrated device type according to a cavity implementation type. Among them, the wavelength tunable light source using an external cavity includes a gain region unit, a wavelength selecting unit, and a wavelength tuning unit. The gain region unit is a region in which lights are generated. The wavelength selecting unit transmits specific wavelengths among the lights generated in the gain region unit. The wavelength tuning unit selects one wavelength from among lights transmitted through the wavelength selecting unit and tunes the selected wavelength.

In addition, the wavelength selecting unit and the wavelength tuning unit perform an external cavity role. The wavelength selecting unit and the wavelength tuning unit allow a light in the cavity to be lased to increase output power of the light and narrow a linewidth thereof. Recently, in an optical coherent tomography system and an automatic optical inspection system, a light source in an effective wavelength tunable driving scheme is necessary for implementing a low-cost and stable system. Accordingly, a high-speed wavelength tuning is necessary.

### SUMMARY OF THE INVENTION

The present invention provides a high-speed wavelength tunable light source.

Embodiments of the present invention provide wavelength tunable light sources including: a super luminescent diode (SLD) generating lights in a predetermined wavelength band; a voltage generating unit generating first and second voltages; a first filter receiving the first voltage from the voltage generating unit, receiving the lights from the SLD, and transmitting, as second lights, lights corresponding to wavelengths separated by a free spectral range (FSR) from each other among the received lights; a second filter receiving the second voltage from the voltage generating unit, receiving the second lights from the first filter, and transmitting, as a third light, a light corresponding to one wavelength among the separated wavelengths among the received second light; and a reflective mirror disposed at an output end of the second filter and reflects the third light transmitted from the second filter, wherein the first filter is formed to adjust the separated wavelengths according the first voltage, and the second filter is formed to adjust the one wavelength according to the second voltage.

In other embodiments of the present invention, wavelength tunable light sources include: an SLD generating lights in a predetermined wavelength band; a voltage generator generating first and second voltages; a first filter receiving the first voltage from the voltage generator, receiving the lights output from the SLD, and transmitting lights corresponding to wavelengths separated by an FSR from each other among the received lights as second lights; a second filter receiving the second voltage from the voltage generator, receiving the second lights from the first filter, and transmitting a light corresponding to one wavelength of wavelengths separated by the common mode range among the received second light as a third light; and a reflective mirror disposed at an output end of the second filter and reflecting the third light transmitted through the second filter, wherein the first filter is formed to adjust the wavelengths, which are separated by the FSR, to be separated by the common mode range according to the first voltage, and the second filter is formed to adjust the one wavelength by the common mode range according to the second voltage.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 illustrates a wavelength tunable light source according to an embodiment of the present invention;

FIG. 2 illustrates spectrum characteristics of a super luminescent diode (SLD) according to an embodiment of the present invention;

FIG. 3 illustrates spectrum characteristics of a first filter according to an embodiment of the present invention;

FIG. 4 illustrates spectrum characteristics of a second filter according to an embodiment of the present invention;

FIG. 5 illustrates a first example of a first wavelength tunable scheme according to an embodiment of the present invention;

FIG. 6 illustrates a second example of the first wavelength tunable scheme according to the embodiment of the present invention;

FIG. 7 illustrates a third example of the first wavelength tunable scheme according to the embodiment of the present invention;

FIG. 8 is a block diagram illustrating a voltage generating unit according to an embodiment of the present invention;

FIG. 9 is a timing diagram illustrating first and second voltage level changes of the first to third examples of the first wavelength tunable scheme according to time;

FIG. 10 illustrates a second wavelength tunable scheme according to another embodiment of the present invention;

FIG. 11 is a block diagram illustrating a voltage generating unit according to another embodiment of the present invention; and

FIG. 12 is a timing diagram illustrating first and second voltage level changes of the second wavelength tunable scheme according to time.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with the accompanying drawings. Like reference numerals refer to like elements throughout. A wavelength tunable light source and operations performed by it to be described below are to be regarded as merely exemplary, and various changes and modifications of the embodiments described herein can be made without departing from the scope and spirit of the invention.

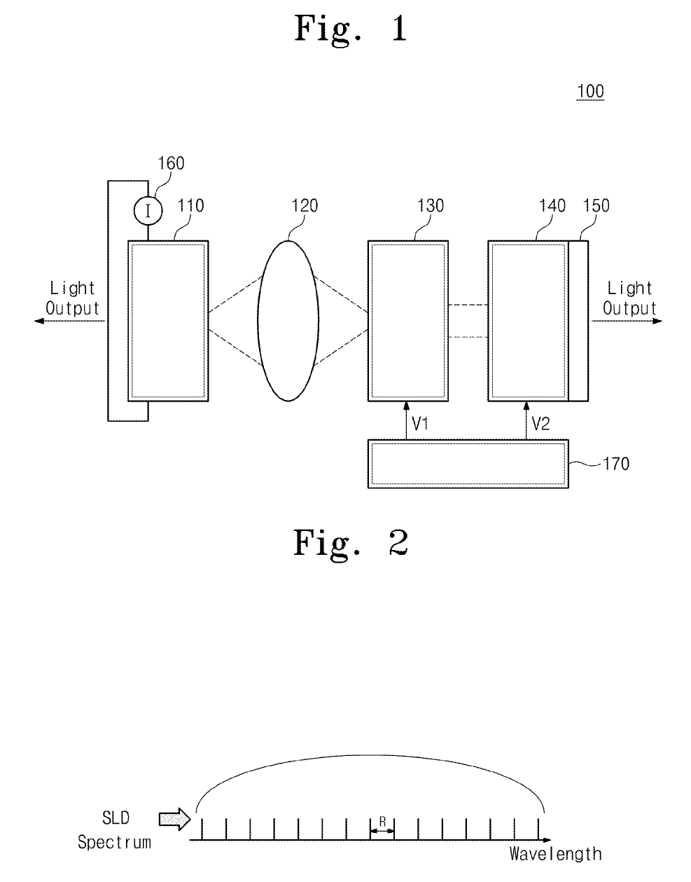

FIG. 1 illustrates a wavelength tunable light source according to an embodiment of the present invention. Referring to FIG. 1, the wavelength tunable light source 100 includes a super luminescent diode (SLD) 110, an optical collimator 120, a first filter 130, a second filter 140, a reflective mirror 150, a current source 160, and a voltage generating unit 170.

The SLD 110 is electrically connected to the current source 160 and receives current injection. The SLD 110 generates lights according to the injected current. The lights generated from the SLD 110 are transferred to the optical collimator 120.

The SLD 110 uses a light amplification phenomenon due to stimulated emission in order to obtain a light output. In an embodiment, for effective operations of the SLD 110, a left surface of the SLD 110 may be manufactured with high reflection (HR) coating. Also, a right surface of the SLD 110 may be manufactured with anti-reflection (AR) coating.

The optical collimator 120 is disposed between the optical collimator 120 and the second filter 140. The first filter 130 receives lights transmitted through the optical collimator 120. The first filter 130 transmits lights corresponding to wavelengths having a free spectral range (FSR) among the lights received from the optical collimator 120. The lights transmitted through the first filter 130 according to the FSR are transferred to the second filter 140.

In an embodiment, the first filter 130 may be a Febry-Perot filter but is not limited thereto. Also, in an embodiment, the first filter 130 may include lead magnesium niobate-lead titanate (PMN-PT) material having high-speed electo-optical response characteristics.

The second filter 140 receives the lights transmitted through the first filter 130. The second filter 140 transmits a light corresponding to any one selected wavelength among the lights received according to the FSR. In an embodiment, the second filter 140 may be a Lyot filter, but is not limited thereto.

The reflective mirror 150 is disposed at an output end of the second filter 140. In an embodiment, the reflective mirror 150 may be disposed as a form of being attached to the second filter 140. The reflective mirror 150 reflects the light transmitted through the second filter 140 to the SLD 110.

The current source 160 injects a current to the SLD 110. Lights are generated from the SLD 110 according to the current injected from the current source 160.

The voltage generating unit 170 is connected respectively to the first and second filters 130 and 140. The voltage generating unit 170 generates a first voltage V1 applied to the first filter 130 and a second voltage V2 applied to the second filter 140. Spectral characteristics of the first filter 130 may be changed according to a level of the first voltage V1 applied to the first filter 130. Spectral characteristics of the second filter 140 may be changed according to a level of the second voltage V2 applied to the second filter 140.

The existing wavelength tunable scheme is that a light output through a wavelength locker is detected by a photodetector (PD). According to a result of the light output, a control signal is fed back to a filter. The existing wavelength tunable light source tunes wavelengths of lights by using a feedback process through the wavelength locker, every time the wavelengths are tuned. However, as describe above, the wavelength tunable light source 100 according to an embodiment of the present invention may tune wavelengths of lights by adjusting voltages applied to the first and second filters 130 and 140. Accordingly, once wavelength tunable characteristics of the wavelength tunable light source 100 are detected according to the applied voltage, a separate feedback process is not further necessary for subsequent operations. Thus, high-speed wavelength tuning is possible.

FIG. 2 illustrates spectral characteristics of the SLD 110 according to an embodiment of the present invention. Referring to FIGS. 1 and 2, the SLD 110 generates lights having a predetermined wavelength band according to a current applied from the current source 160. Also, the predetermined wavelength band of the SLD spectrum includes a plurality of common mode ranges R. A lased wavelength may be output on the basis of one common mode among the common modes.

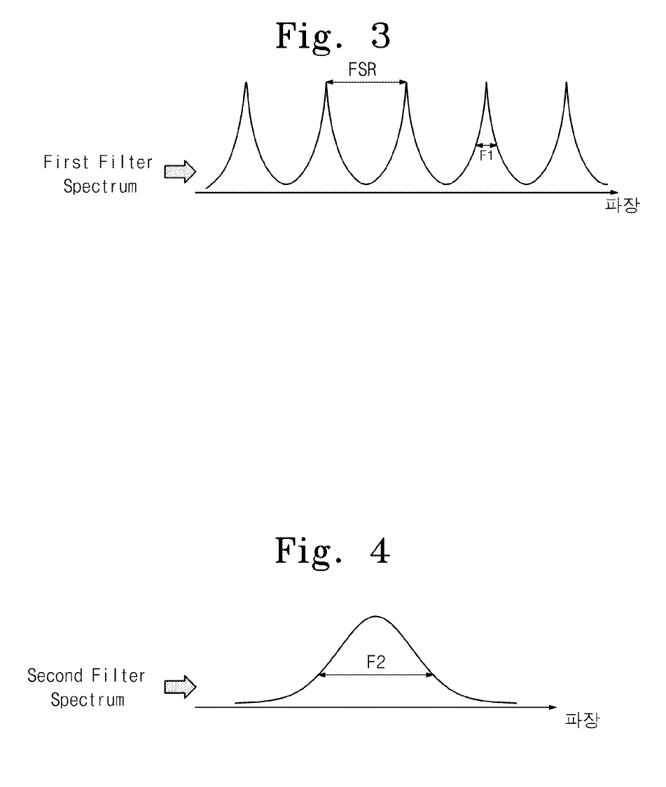

FIG. 3 illustrates spectrum characteristics of the first filter according to an embodiment of the present invention. Referring to FIGS. 1 to 3, the first filter 130 has repetitive pass bands F1. An interval between the pass bands may be the FSR. In an embodiment, the pass band F1 of the first filter 130 is formed as being narrower than the common mode range R.

FIG. 4 illustrates spectrum characteristics of the second filter 140 according to an embodiment of the present invention. Referring to FIG. 4, the second filter 140 (see FIG. 1) selects a light corresponding to one wavelength among the lights transmitted through the first filter 130. In an embodiment, a pass band F2 of the second filter 140 may be realized double or three times wider than the FSR of the first filter 130.

Furthermore, the wavelength tunable light source 100 according to the present invention may output a light according the first or second wavelength tuning scheme. In the first wavelength tuning scheme, the light is output according to the FSR shown in FIG. 3 for an entire wavelength tunable region. In the second wavelength tuning scheme, the light is output according to the common mode range R shown in FIG. 2 for the entire wavelength tunable region.

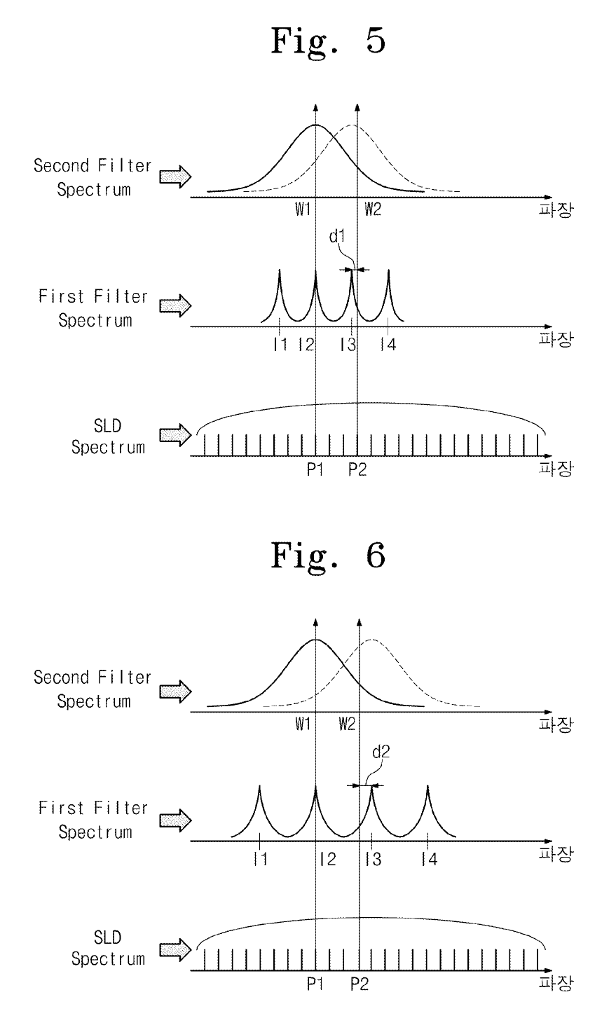

FIGS. 5 to 7 illustrate the first wavelength tuning scheme according to an embodiment of the present invention. Referring to FIGS. 5 to 7, after a light is output from a point P1, a light is output from a point P2 according to the FSR. The first wavelength tuning scheme tunes wavelengths of the first and second spectra in order to allow a light to be output from the point P2, after the light is output from the point P1. Also, the first wavelength tuning scheme sequentially outputs lights according to the FSR for a constant period on the basis of a scheme that lights are output from the two points P1 and P2.

FIG. 5 shows a first example of the first wavelength tuning scheme. Referring to FIG. 5, a light is output that a point in the SLD spectrum, a peak of the first filter spectrum, and a peak of the second filter spectrum are coincided with each other. For example, the point P1 of the SLD spectrum and a point 12 of the first filter spectrum are coincided on a vertical line. Also, a point 12 of the first filter spectrum and a point W1 of the second filter spectrum are coincided on a vertical line. Accordingly, a light may be output externally at the point P1. However, since a point P2 of the SLD spectrum and a point 13 of the first filter spectrum are not coincided on a vertical line, a very weak light output appears in the second filter spectrum.

According to a level of the first voltage V1, wavelength characteristics of the first filter spectrum is tuned. For example, when the level of the first voltage V1 is increased, the wavelength of the first filter spectrum moves in a direction from I1 to I4. Alternatively, as the level of the first voltage V1 is increased, the FSR of the first filter 130 may be increased. On the contrary, when the level of the first voltage V1 is decreased, the wavelength of the first filter spectrum moves in a direction from I4 to I1. Alternatively, as the level of the first voltage V1 is decreased, the FSR of the first filter spectrum is tuned according to the level of the first voltage V1 and arranged with the common mode.

According to a level of the second voltage V2, wavelength characteristics of the second filter spectrum is tuned. For example, when the level of the second voltage V2 is increased, the wavelength of the second spectrum moves in a direction from W1 to W2. As described above, the wavelength of the second filter spectrum is tuned according to the level of the second voltage V2 and arranged with the common mode.

The first example shown in FIG. 5 is a case where the FSR is shorter than integer multiple of the common mode range R by a constant length d1. Thus, in the first example, the level of the first voltage V1 applied to the first filter 130 is increased. The level of the second voltage V2 applied to the second filter 140 is also increased.

In detail, after the light is output at the point P1, in order for a light to be output at the point P2, the level of the first voltage V1 is increased for allowing the FSR to be moved in a direction to the point P2 by the constant length d1. The level of the second voltage V2 is increased for allowing a wavelength of the second filter spectrum to be moved from a first peak point W1 to a second peak point W2. Accordingly, the light may be output externally at the point P2.

FIG. 6 illustrates a second example of the first wavelength tuning scheme according to the embodiment of the present invention. Referring to FIG. 6, the second example is a case where the FSR is larger than integer multiple of the common mode range R. Accordingly, in the second example, the level of the first voltage V1 applied to the first filter 130 (see FIG. 1) is decreased. The level of the second voltage V2 applied to the second filter 140 is increased.

In detail, after the light is output at point P1, in order for a light to be output at the point P2, the level of the first voltage V1 is decreased for allowing the FSR to be moved in a direction to the point P2 by a constant length d2. The level of the second voltage V2 is increased for allowing a wavelength of the second filter spectrum to be moved from a first peak point W1 to a second peak point W2. Accordingly, the light may be output externally at the point P2.

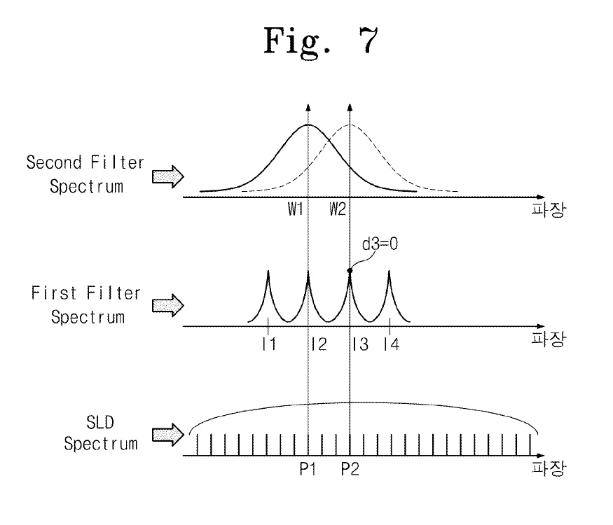

FIG. 7 illustrates a third example of the first wavelength tuning scheme according to the embodiment of the present invention. Referring to FIG. 3, the third example is a case where the FSR is the same as integer multiple of the common mode range R. Accordingly, the level of the first voltage V1 applied to the first filter 130 is kept identically. The level of the second voltage V2 applied to the second filter 140 is increased. The level of the second voltage V2 is increased for allowing the wavelength of the second filter spectrum to be moved from the first peak point W1 to the second peak point W2. Accordingly, the light may be output externally at point P2.

As described-above, the first wavelength tuning scheme adjusts the levels of the first and second voltages V1 and V2 according to the first to third examples. The first wavelength tuning scheme lases a wavelength according to the constant FSR.

It is also described that a peak point of a spectrum is moved toward a right side according to the increases of the voltages applied to the first and second filters 130 and 140. However, a wavelength tuning direction according to the levels of the first and second voltages V1 and V2 may be differed according to materials forming the first and second filters 130 and 140. Accordingly, the peak point of the spectrum may be moved toward the left side according to the increases of the voltages applied to the first and second filters 130 and 140. Thus, when the wavelength is tuned, the first and second spectral wavelengths and common modes may be arranged by adjusting each level of the voltages applied to the first and second filters 130 and 140.

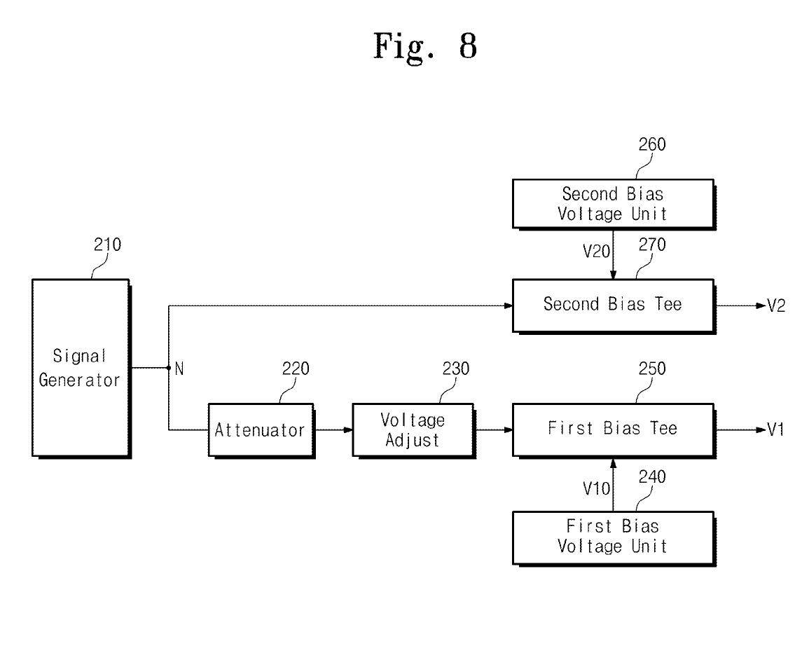

FIG. 8 is a block diagram illustrating a voltage generating unit according to an embodiment of the present invention. Referring to FIG. 8, the voltage generating unit 200 includes a signal generator 210, an attenuator 220, a voltage adjustor 230, a first bias voltage unit 240, a first bias tee 250, a second bias voltage unit 260, and a second bias tee 270.

The signal generator 210 generates an electrical signal having a uniform waveform. For example, the signal generator 210 may generate electrical signals having various waveforms. The signal generator 210 branches an electrical signal generated in a uniform waveform and applies the branched electrical signals respectively to the attenuator 220 and the second bias tee 250.

The attenuator 220 is electrically connected to the signal generator 210 and receives an electrical signal. The attenuator 220 attenuates an amplitude of the electrical signal received from the signal generator 210. The attenuator 220 transfers a small electrical signal whose amplitude becomes attenuated to the voltage adjustor 230.

The voltage adjustor 230 is electrically connected to the attenuator 220 and the first bias tee 250, respectively. The voltage adjustor 230 receives the small electrical signal whose amplitude becomes attenuated from the attenuator 220. The voltage adjustor 230 generates a voltage adjusting signal according to each of the first to third examples of the first wavelength tuning scheme.

The voltage adjustor 230 transfers the generated voltage adjusting signals to the first bias tee 250. Also, in an embodiment, the voltage adjustor 230 may select the voltage adjusting signals according to a pre-stored table. The table may include various waveforms on the basis of the first filter and wavelength characteristics of the SLD spectrum. Accordingly, the voltage adjustor 230 may select the voltage adjusting signals on the basis of the pre-stored table.

In the first example shown in FIG. 5, the voltage adjustor 230 generates the voltage adjusting signal from the received small electrical signal from the attenuator 220. The small electrical signal increases the level of the first voltage V1 on the basis of the first bias voltage V10. In the second example, the voltage adjustor 230 generates an inverted electrical signal that the small electrical signal is inverted. The inverted electrical signal is that a sign of the first voltage V1 is changed, that is, a phase thereof is inverted, on the basis of the first bias voltage V10. The reference voltage signal keeps the level of the first bias voltage V10 identically. The reference voltage signal may be a ground voltage.

As described above, the voltage adjustor 230 selects one of the voltage adjusting signals according to the first to third examples according to optical wavelength characteristics of the first filter spectrum.

The first bias voltage unit 240 is electrically connected to the first bias tee 250. The first bias voltage unit 240 generates the first bias voltage V10 and transfers the first bias voltage V10 to the first bias tee 250.

The first bias tee 250 is electrically connected to the voltage adjustor 230 and the first bias voltage unit 240. The first bias tee 250 receives the voltage adjusting signal from the voltage adjustor 230. Also, the first bias tee 250 receives the first bias voltage V10 from the first bias voltage unit 240. The first bias tee 250 synthesizes the received voltage adjusting signal and the first bias voltage V10 and transfers the synthesized voltage as the first voltage V1. According to the level of the first voltage V1, the optical wavelength of the first filter spectrum is tuned.

The second bias voltage unit 260 is electrically connected to the second bias tee 270. The second bias voltage unit 260 generates the second bias voltage V20 and transfer the second bias voltage V20 to the second bias tee 270.

The second bias tee 270 is electrically connected to the signal generator 210 and the second bias voltage unit 260. The second bias tee 270 receives an electrical signal from the signal generator 210. Also, the second bias tee 270 receives the second bias voltage V20 from the second bias voltage unit 260. The second bias tee 270 synthesizes the received electrical signal and the second bias voltage V20 and output the synthesized voltage as the second voltage V2. According to the level of the second voltage V2, an optical wavelength of the second filter spectrum is tuned.

Furthermore, in the first wavelength tuning scheme according to the present invention, the level of the first voltage V1 is lower than that of the second voltage V2. This is because a wavelength tuning width in the second filter spectrum is greater than that in the first filter spectrum.

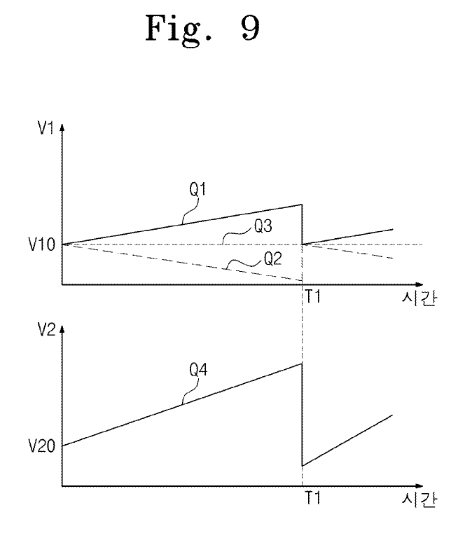

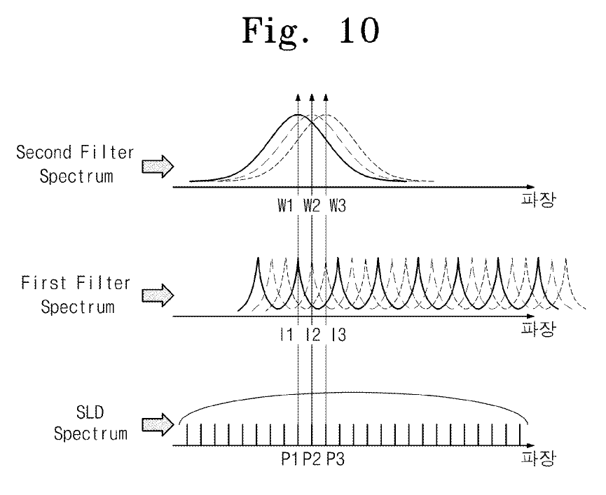

FIG. 9 is a timing diagram illustrating changes of the level of the first voltage according to time in the first to third examples of the first wavelength tuning scheme. Referring to FIGS. 8 and 9, in the first example, the voltage adjustor 230 transfer the voltage adjusting signal based on the small electrical signal to the first bias tee 250. The first bias tee 250 increases Q1 an output level of the first voltage V1 for a constant period T1 on the basis of the voltage adjusting signal. Due to the increase of the output level of the first voltage V1, the optical wavelength of the first filter spectrum may be moved by a distance d1 as shown in FIG. 5.

In the second example, the voltage adjustor 230 transfers the voltage adjusting signal based on the inverted electrical signal to the first bias tee 250. The first bias tee 250 decreases Q2 the output level of the first voltage V1 for the constant period T1 on the basis of the voltage adjusting signal. Due to the decrease of the output level of the first voltage V1, the optical wavelength of the first filter spectrum may be moved by a distance d2 as shown in FIG. 5.

In the third example, the voltage adjustor 230 transfers the voltage adjusting signal based on the reference voltage signal to the first bias tee 250. The first bias tee 250 keeps the output level of the first voltage V1 identically for the constant period T1 on the basis of the voltage adjusting signal. By keeping the constant output level of the first voltage V1 identically, the optical wavelength of the first filter spectrum is not tuned.

The output level of the second voltage V2 is increased Q4 for the constant period T1. The second bias tee 270 increases the output level of the second voltage V2 on the basis of the received electrical signal from the signal generator 210. Due to the increase of the second voltage V2, the optical wavelength of the second filter spectrum is tuned.

FIG. 10 illustrates a second wavelength tuning scheme according to another embodiment of the present invention. Referring to FIG. 10, the second wavelength tuning scheme outputs a light according to the common mode range F of the SLD spectrum shown in FIG. 2 for an entire spectral domain. For example, when a light is output at a point P1, the next light output occurs at a point P2 according to the common mode range R. After the light is output at the point P2, a light is output at a point P3. As described above, in the second wavelength tuning scheme, lights are sequentially output according to the common mode range R. Also, like the first wavelength tuning scheme, the second wavelength tuning scheme adjusts the levels of the first and second voltages V1 and V2 respectively and tunes the wavelengths.

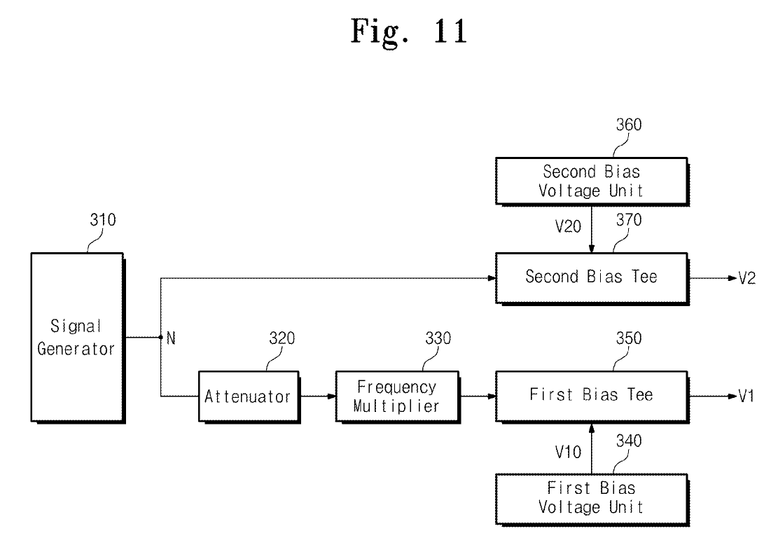

FIG. 11 is a block diagram illustrating a voltage generating unit according to another embodiment. Referring to FIG. 11, the first and second voltages V1 and V2 are generated from a signal generator 310, an attenuator 320, a frequency multiplier 330, a first bias voltage unit 340, a first bias tee 350, a second bias voltage unit, and a second bias tee 370.

Elements shown in FIG. 11 except the frequency multiplier 330 have the same structures as those shown in FIG. 8 respectively and operate identically.

The frequency multiplier 330 generates the voltage adjusting signals allowing the first voltage V1 to be output according to the common mode range R. The frequency multiplier 330 transfers the generated voltage adjusting signals to the first bias tee 350. Also, in an embodiment, the frequency multiplier 330 may include a table having various kinds of voltage adjusting signals. The frequency multiplier 330 generates the voltage adjusting signals on the basis of data included in the table according to characteristics of the first spectrum.

The first bias tee 350 receives the voltage adjusting signals from the frequency multiplier 330 and the first bias voltage V10 from the first bias voltage unit 340. The first bias tee 350 synthesizes the voltage adjusting signals and the first bias voltage V10 and transfers the synthesized voltage as the first voltage V1. Every time the first voltage V1 is output, the wavelength of the first filter spectrum is tuned in the common mode range R.

The second bias tee 370 is electrically connected to the signal generator 310 and the second bias voltage unit 360. The second bias tee 370 receives an electrical signal from the signal generator 310. Also, the second bias tee 370 receives the second bias voltage V20 from the second bias voltage unit 360. The second bias tee 370 synthesizes the received electrical signal and the second bias voltage V20 and outputs the synthesized voltage as the second voltage V2. In addition, the second bias tee 370 outputs the second voltage V2 which allows an optical wavelength of the second filter spectrum to be tuned.

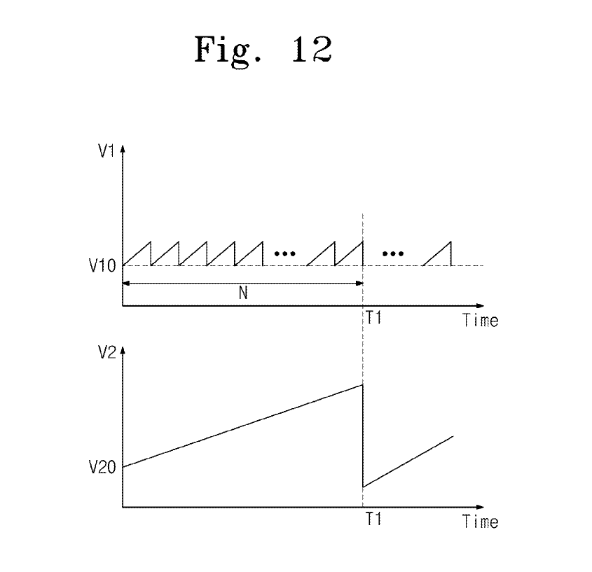

FIG. 12 is a timing diagram illustrating changes of the first and second voltage levels according to a time of the second wavelength tuning scheme. Referring to FIGS. 11 and 12, the first bias tee 350 outputs the first voltage V1 N times for one period T1. In detail, it is assumed that the number of FSRs included in the first filter characteristic spectrum is L. It is also assumed that that the number of common mode ranges Rs included in a predetermined FSR is B. Thus, for one period T1, the number of times N that the first voltage V1 is output from the first bias tee 350 becomes LxB.

The output level of the second voltage V2 is increased for a constant period T1. The second bias tee 370 increases the output level of the second voltage V2 on the basis of the electrical signal received from the signal generator 310. Due to the increase of the output level of the second voltage V2, the optical wavelength of the second filter spectrum is tuned. Also, the output level of the second voltage V2 is increased according to the common mode range R.

As described above, a light is output according to the common mode range R in the second wavelength tuning scheme. Accordingly, the larger number of optical outputs may be realized in the second wavelength tuning scheme, compared to the first wavelength tuning scheme.

According to the embodiments, the wavelength tunable light source includes first and second filters for tuning lased wavelengths. The wavelength tunable light source tunes lased wavelengths according to first and second voltage levels. Thus, the wavelength tunable light source of the present invention enables wavelengths to be tuned in higher speed, compared to a related art wavelength tuning scheme in which a driving voltage is adjusted every time a light is output.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wavelength tunable light source comprising:
a super luminescent diode (SLD) generating lights in a predetermined wavelength band;
a voltage generating unit generating first and second voltages;
a first filter receiving the first voltage from the voltage generating unit, receiving the lights from the SLD, and transmitting, as a second light, a portion of the lights corresponding to wavelengths separated by a free spectral range (FSR) from each other among the received lights;
a second filter receiving the second voltage from the voltage generating unit, receiving the second light from the first filter, and transmitting, as a third light, a portion of the second light corresponding to one wavelength among the separated wavelengths among the received second light; and
a reflective mirror disposed at an output end of the second filter and reflects the third light transmitted from the second filter,
wherein the first filter is formed to adjust the separated wavelengths according the first voltage, and the second filter is formed to adjust the one wavelength according to the second voltage.

2. The wavelength tunable light source of claim 1, further comprising an optical collimator transmitting the lights output from the SLD to transfer to the first filter.

3. The wavelength tunable light source of claim 1, wherein the voltage generating unit comprises:
a signal generator outputting an electrical signal;
an attenuator receiving the electrical signal from the signal generator, and attenuating an amplitude of the electrical signal to generate a small electrical signal;
a voltage adjustor receiving the small electrical signal from the attenuator and generating a voltage adjusting signal on the basis of the small electrical signal;
a first bias voltage unit generating the first bias voltage; and
a first bias tee receiving the voltage adjusting signal from the voltage adjustor, receiving the first bias voltage from the first bias voltage unit, and synthesizing the voltage adjusting signal and the first bias voltage to output the synthesized voltage as the first voltage,
wherein the first bias tee is formed to adjust a level of the first voltage on the basis of the small electrical signal.

4. The wavelength tunable light source of claim 3, wherein the voltage adjustor selects one of the small electrical signal, an inverted electrical signal which is generated by inverting the small electrical signal, and a reference voltage signal, and output the selected signal as the voltage adjusting signal.

5. The wavelength tunable light source of claim 4, wherein the lights in the predetermined wavelength band comprise wavelengths separated by a common mode range from each other, and
when the FSR is shorter than an integer multiple of the common mode range, the voltage adjustor generates the small electrical signal as the voltage adjusting signal.

6. The wavelength tunable light source of claim 4, wherein the lights in the predetermined wavelength band comprise wavelengths separated by a common mode range from each other, and
when the FSR is longer than an integer multiple of the common mode range, the voltage adjustor generates the inverted electrical signal as the voltage adjusting signal.

7. The wavelength tunable light source of claim 4, wherein the lights in the predetermined wavelength band comprise wavelengths separated by a common mode range from each other, and
when the FSR is the same as an integer multiple of the common mode range, the voltage adjustor generates the reference voltage signal as the voltage adjusting signal.

8. The wavelength tunable light source of claim 7, wherein the reference voltage signal is a ground signal.

9. The wavelength tunable light source of claim 3, wherein the voltage generating unit further comprises:
a second bias voltage unit generating a second bias voltage; and
a second bias tee receiving the electrical signal, receiving the second bias voltage from the second bias voltage unit, and synthesizing the electrical signal and the second bias voltage to output the synthesized voltage as the second voltage.

10. A wavelength tunable light source comprising:
an SLD generating lights in a predetermined wavelength band;
a voltage generator generating first and second voltages;
a first filter receiving the first voltage from the voltage generator, receiving the lights output from the SLD, and transmitting a portion of the lights corresponding to wavelengths separated by an FSR from each other among the received lights as second lights;
a second filter receiving the second voltage from the voltage generator, receiving the second lights from the first filter, and transmitting a portion of the second light corresponding to one wavelength of wavelengths separated by the common mode range among the received second light as a third light; and
a reflective mirror disposed at an output end of the second filter and reflecting the third light transmitted through the second filter,
wherein the first filter is formed to adjust the wavelengths, which are separated by the FSR, to be separated by the common mode range according to the first voltage, and the second filter is formed to adjust the one wavelength by the common mode range according to the second voltage.

11. The wavelength tunable light source of claim 10, wherein the voltage generating unit comprises:
a signal generator outputting an electrical signal;
an attenuator attenuating an amplitude of the electrical signal to generate a small electrical signal;
a frequency multiplier receiving the small electrical signal from the attenuator and generating a voltage adjusting signal for controlling the first voltage to be output for every common mode range;
a first bias voltage unit generating a first bias voltage; and
a first bias tee receiving the voltage adjusting signal from the frequency multiplier, receiving the first bias voltage from the first bias voltage unit, and synthesizing the voltage adjusting signal and the first bias voltage to output the synthesized voltage as the first voltage,
wherein the first bias tee is formed to adjust a level of the first voltage on the basis of the small electrical signal.

12. The wavelength tunable light source of claim 10, wherein the voltage generating unit further comprises:
a second bias voltage unit generating a second bias voltage; and
a second bias tee receiving the electrical signal, receiving the second bias voltage through the second bias voltage unit, and synthesizing the electrical signal and the second bias voltage to output the synthesized voltage as the second voltage.
